(19) United States
(12) Patent Application Publication
(10) Pub. No.: US 2020/0114794 A1
(43) Pub. Date: Apr. 16, 2020

(54) HINGED MULTI-TIER STORAGE COMPARTMENTS

(71) Applicant: GM Global Technology Operations LLC, Detroit, MI (US)

(72) Inventors: Karly S. Hoggard, Kalkaska, MI (US); Nathan E. Ruddy, Eagle, MI (US)

(21) Appl. No.: 16/161,576

(22) Filed: Oct. 16, 2018

(51) Int. Cl. B60N 2/75; B60R 7/04

(52) U.S. Cl. CPC B60N 2/793; B60R 2011/0007; B60R 7/04

(57) ABSTRACT

A console for a motor vehicle includes a console compartment formed in the console and having first, second, third, and fourth sides connected to a bottom side and partially enclosing a first volume, and a movable compartment lid disposed overtop the console compartment and articulating through a first range of motion. The console further includes a plurality of storage compartments in movable connection with each of the others of the plurality of storage compartments and in movable connection with the console compartment and the movable compartment lid, such that when the lid articulates through the first range of motion, the plurality of storage compartments move vertically and horizontally with respect to the console compartment and the movable compartment lid.

### INTRODUCTION

The statements in this section merely provide background information relating to the present disclosure, and may not constitute prior art.

The present disclosure generally relates to motor vehicles, and more specifically to storage within center consoles of motor vehicles. Motor vehicles commonly include center consoles disposed between the front driver and passenger seats. Center consoles typically include pockets, holders, and slots for storing various items, such as cups, pens, coins, etc. Center consoles also often include storage compartments for storing larger items, such as compact disc jewel cases, road maps, and sunglasses. The storage compartments are covered by hinged lids that serve as armrests for the front occupants. Conventional center console designs are, however, usually box-shaped and lack dividers or other similar features for organizing the contents of the storage compartment. Additionally, conventional center console designs often offer limited storage solutions beneath the armrest itself. Such limited storage solutions can manifest in disorganization within the storage compartment. Accordingly, there is a need in the art for new and improved center console storage compartments that provide a low-cost, relatively simple construction, and improved organization for users of storage space within motor vehicle center consoles.

### SUMMARY

According to several aspects of the present disclosure a console for a motor vehicle includes a console compartment formed in the console and including a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable compartment lid disposed overtop the console compartment and articulating through a first range of motion. The console further includes a plurality of storage compartments in movable connection with each of the others of the plurality of storage compartments and in movable connection with the console compartment and the movable compartment lid, when the lid articulates through the first range of motion, the plurality of storage compartments move vertically and horizontally with respect to the console compartment and the movable compartment lid.

In another aspect of the present disclosure the console compartment further includes a plurality of console dividers dividing the first volume into a plurality of partial volumes.

In yet another aspect of the present disclosure the plurality of storage compartments are disposed within a first partial volume of the plurality of partial volumes when the movable compartment lid is in a closed position, and the plurality of storage compartments are disposed outside of the first partial volume when the movable compartment lid is in an open position.

In yet another aspect of the present disclosure the plurality of storage compartments further includes a first storage compartment movably connected to the console compartment by a first hinge link and a second hinge link, and by a first hinge pin and a second hinge pin; a second storage compartment movably connected to the first compartment by a third hinge link, and a fourth hinge link, and by a third hinge pin, a fourth hinge pin, a fifth hinge pin, and a sixth hinge pin; a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid.

In yet another aspect of the present disclosure each of the first, second, and third storage compartments includes a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion.

In yet another aspect of the present disclosure the first hinge link is disposed in a hinge link receiver formed with the first storage compartment, and the first hinge link in the hinge link receiver is immobilized relative to the first storage compartment.

In yet another aspect of the present disclosure the movable connection between the third storage compartment and the movable compartment lid further includes a sliding connection, the sliding connection includes a slider extending from the third storage compartment into a racetrack, movement of the slider within the racetrack is limited by a stop disposed in the racetrack.

In yet another aspect of the present disclosure the racetrack further includes a slot formed in an underside of the movable compartment lid.

In yet another aspect of the present disclosure the racetrack further includes a ball bearing track.

In yet another aspect of the present disclosure the racetrack further includes a gasket.

In yet another aspect of the present disclosure when the movable compartment lid articulates through the first range of motion from the closed position to the open position, the third storage compartment articulates vertically and horizontally through a second range of motion out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment.

In yet another aspect of the present disclosure a console having hinged storage compartments for a motor vehicle includes a console compartment formed in the console and including a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable compartment lid disposed overtop the console compartment and articulating through a first range of motion. The console further includes a plurality of storage compartments in movable connection with each of the others of the plurality of storage compartments and in movable connection with the console compartment and the movable compartment lid, the plurality of storage compartments including a first storage compartment movably connected to the console compartment by a first hinge link and a second hinge link, and by a first hinge pin and a second hinge pin; a second storage compartment movably connected to the first compartment by a third hinge link, and a fourth hinge link, and by a third hinge pin, a fourth hinge pin, a fifth hinge pin, and a sixth hinge pin; and a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid. When the lid articulates through the first range of motion, the plurality of storage compartments move vertically and horizontally with respect to the console compartment and the movable compartment lid.

In yet another aspect of the present disclosure the console compartment further includes a plurality of console dividers dividing the first volume into a plurality of partial volumes, and the plurality of storage compartments are disposed within a first partial volume of the plurality of partial volumes when the movable compartment lid is in a closed position, and the plurality of storage compartments are disposed outside of the first partial volume when the movable compartment lid is in an open position.

In yet another aspect of the present disclosure when the movable compartment lid articulates through the first range of motion from the closed position to the open position, the third storage compartment articulates through a second range of motion vertically and horizontally out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment.

In yet another aspect of the present disclosure each of the first, second, and third storage compartments includes a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion.

In yet another aspect of the present disclosure the first hinge link is disposed in a hinge link receiver formed with the first storage compartment, and the first hinge link in the hinge link receiver is immobilized relative to the first storage compartment.

In yet another aspect of the present disclosure the movable connection between the third storage compartment and the movable compartment lid further includes a sliding connection, the sliding connection includes a slider extending from the third storage compartment into a racetrack formed in the underside of the movable compartment lid, the racetrack is a substantially linear slot, the slider moves through a fifth range of motion, and the fifth range of motion is limited by a stop disposed in the racetrack.

In yet another aspect of the present disclosure the racetrack further includes a ball bearing track, and a gasket is disposed in the racetrack.

In yet another aspect of the present disclosure the slider further includes a pin extending from the third storage compartment and into the racetrack, the pin has a substantially T-shaped cross section, and the pin is retained within the racetrack.

In yet another aspect of the present disclosure a center console for a motor vehicle having hinged storage compartments includes a console compartment formed in the console and defining a first volume, and a movable compartment lid disposed overtop the console compartment and articulating through a first range of motion. The console further includes a plurality of storage compartments in movable connection with each of the others of the plurality of storage compartments and in movable connection with the console compartment and the movable compartment lid, the plurality of storage compartments including a first storage compartment movably connected to the console compartment by a first hinge link and a second hinge link, and by a first hinge pin and a second hinge pin; the first hinge link is disposed in a hinge link receiver formed with the first storage compartment, the first hinge link in the hinge link receiver is immobilized relative to the first storage compartment, and the first hinge pin travels in a substantially linear slot-shaped hinge pin receiver formed in the console compartment. The console further includes a second storage compartment movably connected to the first compartment by a third hinge link, and a fourth hinge link, and by a third hinge pin, a fourth hinge pin, a fifth hinge pin, and a sixth hinge pin. The console further includes a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid through a sliding connection, the sliding connection includes a slider having a substantially T-shaped cross section and extending from the third storage compartment into a racetrack formed in the underside of the movable compartment lid, the racetrack is a substantially linear slot. The console further includes a plurality of console dividers dividing the first volume into a plurality of partial volumes, and the plurality of storage compartments are disposed within a first partial volume of the plurality of partial volumes when the movable compartment lid is in a closed position, and the plurality of storage compartments are disposed outside of the first partial volume when the movable compartment lid is in an open position. When the movable compartment lid articulates through the first range of motion from the closed position to the open position, the third storage compartment articulates through a second range of motion vertically and horizontally out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment, and the slider moves through a fifth range of motion within the racetrack, and the fifth range of motion is limited by a stop within the racetrack.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an environmental view of a motor vehicle equipped with a center console having hinged multi-tier storage compartments according to an aspect of the present disclosure;

FIG. 2A is a perspective view of a portion of center console having hinged multi-tier storage compartments according to an aspect of the present disclosure;

FIG. 2B is a perspective view of the center console of FIG. 2A having a sliding joint according to an aspect of the present disclosure; and

FIG. 2C is a perspective view of the center console of FIG. 2A having a plurality of sliding pin joints according to an aspect of the present disclosure.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. Likewise, the terms “forward”, “rear”, “inner”, “inwardly”, “outer”, “outwardly”, “above”, and “below” are terms used relative to the orientation of the motor vehicle as shown in the drawings of the present application. Thus, “forward” refers to a direction toward a front of a motor vehicle, “rearward” refers to a direction toward a rear of a motor vehicle, “passenger” refers to a direction towards a passenger side of the motor vehicle (right-hand side in the context of this particular application), “driver” or “driver side” refers to a direction towards the driver's side of the motor vehicle (right-hand side in the context of this particular application), “inner” and “inwardly” refers to a direction towards the interior of a motor vehicle, and “outer” and “outwardly” refers to a direction towards the exterior of a motor vehicle, “below” refers to a direction towards the bottom of the motor vehicle, and “above” refers to a direction towards a top of the motor vehicle. These and similar directional terms are not to be construed to limit the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of descristorage compartment particular example embodiments only and is not intended to be limiting. As used herein, the singular forms “a,” “an,” and “the” may be intended to include the plural forms as well, unless the context clearly indicates otherwise. The terms “comprises”, “includes,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “disposed on,” “connected to,” or “coupled to” another element or layer, it may be directly on, engaged, disposed, connected or coupled to the other element or layer, or intervening elements or layers may be present. In contrast, when an element is referred to as being “directly on,” “directly engaged to,” “directly disposed on,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all storage compartmentations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The following description is merely exemplary in nature and is not intended to limit the present disclosure, application, or uses.

The system and methodology described herein can be utilized to enhance a determination when a transmission is in a park position or in an out-of-park position. While the approach and methodology are described below with respect to vehicle applications, one of ordinary skill in the art would appreciate that an automotive application is merely exemplary, and that the concepts disclosed herein may also be applied to any other suitable compartments, and more specifically to suitable storage compartments within a motor vehicle. The term “vehicle” as described herein can be construed broadly to include not only a passenger automobile, but any other vehicle including, but not limited to, rail systems, planes, off-road sport vehicles, robotic vehicles, motorcycles, trucks, sport utility vehicles (SUVs), recreational vehicles (RVs), marine vessels, aircraft, farming vehicles, construction vehicles, and the like.

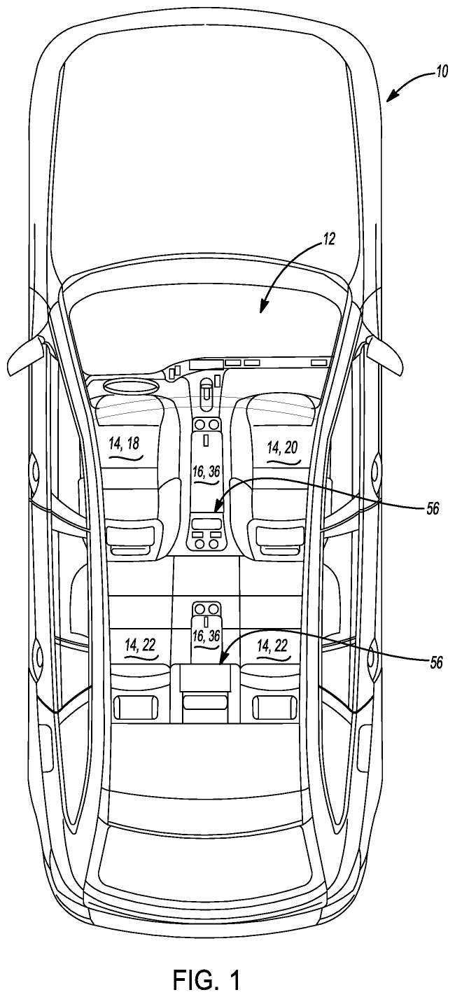

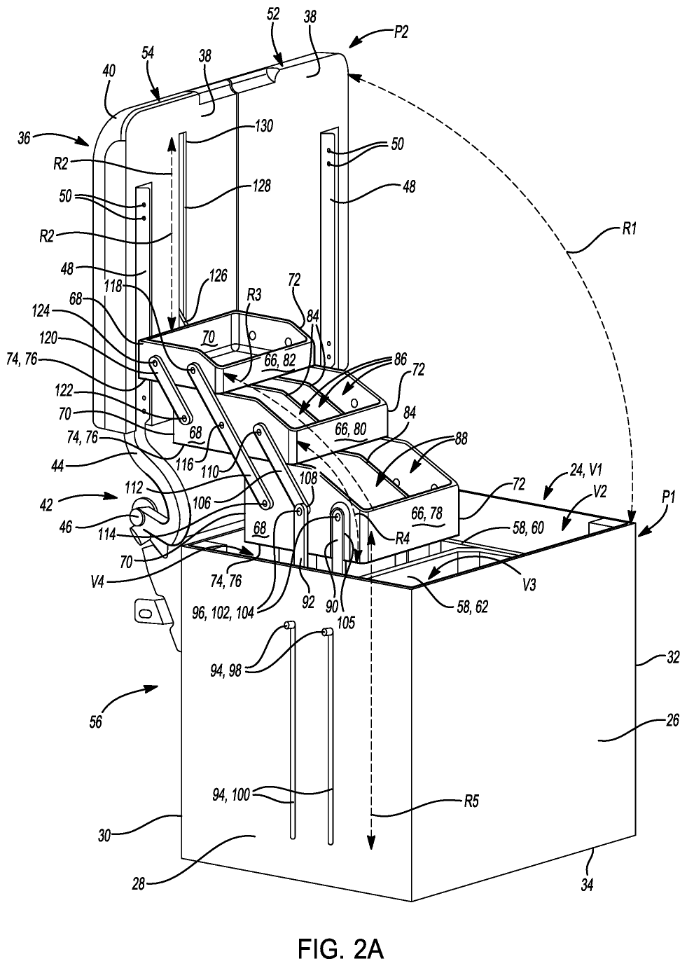

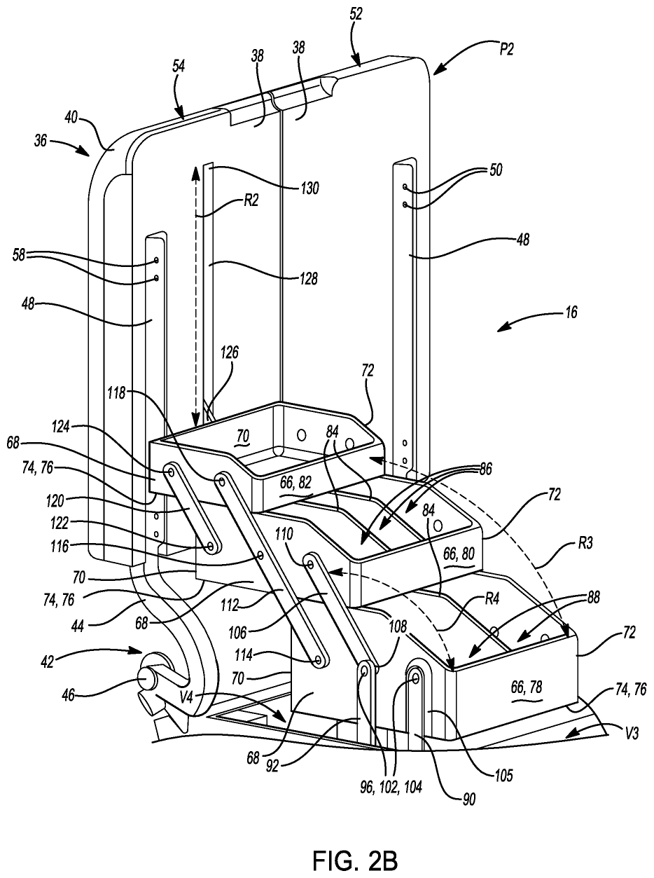

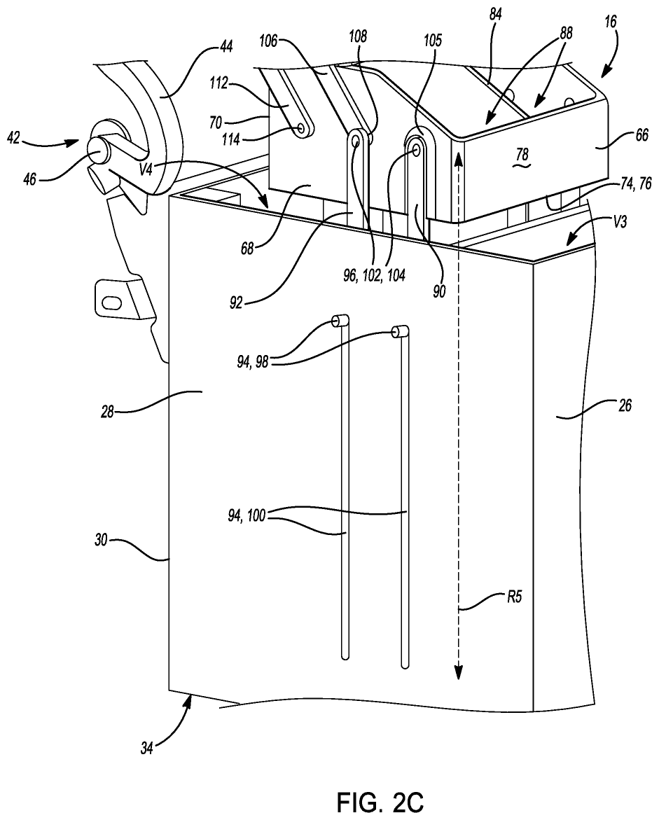

Referring now to FIGS. 1, 2A and 2B, a motor vehicle is shown and generally indicated by reference number 10. While the motor vehicle 10 illustrated is a car, it should be appreciated that the motor vehicle 10 may be any type of vehicle, including a car, a van, a truck, a motor home, or any other such vehicle without departing from the scope or intent of the present disclosure. The motor vehicle 10 includes a passenger compartment 12 having a plurality of seats 14. A center console 16 is disposed between a driver seat 18 and a passenger seat 20. While the center console 16 has been described as being between the driver seat 18 and the passenger seat 20 additional center consoles 16 may be placed elsewhere throughout the passenger compartment 12. For example, an additional center console 16 may be disposed between the rear seats 22 of the passenger compartment 12 without departing from the scope or intent of the present disclosure. The center console 16 serves several functions. In some aspects, the center console 16 provides a driver, a passenger, or rear seat passengers, or all of the above, a resting place for an arm. In other aspects, the center console 16 defines a console compartment 24.

The console compartment 24 has a first or front side 26 extending towards and connected at an angle to a second or passenger side 28. The passenger side 28 extends towards and is connected at an angle to a third or rear side 30. The rear side 30 extends towards and is connected at an angle to a fourth or driver side 32, and the driver side 32 extends towards and is connected at an angle to the front side 26. The console compartment 24 also has a bottom 34. The bottom 34 is connected at an angle to each of the front, passenger, rear, and driver sides 26, 28, 30, 32. A movable compartment lid 36 covers the console compartment 24. In several aspects, the compartment lid 36 has a substantially planar underside 38 and a padded top 40. The padded top 40 provides a soft and forgiving surface on which it is comfortable for an occupant of the motor vehicle 10 to rest an arm or other extremity. The lid 36 may take any of a variety of forms without departing from the scope or intent of the present disclosure. In some aspects, the lid 36 is rotatably connected to the center console 16 at a hinge 42. The hinge 42 allows the lid 36 to articulate through a first range of motion “R1” from a closed position “P1” to an open position “P2”. The hinge 42 includes a hinge arm 44 extending from a pivot pin 46 to an attachment portion 48. The pivot pin 46 of some examples is formed unitarily with either the hinge arm 44 or the center console 16. In a further example, the pivot pin 46 is a separate component from both the hinge arm 44 and the center console 16 and is assembled with the hinge arm 44 and the center console 16 during production. The attachment portion 48 has a plurality of attachment features 50. In several aspects, the attachment features 50 are mechanical fasteners such as press fittings, screw, bolts, nuts, rivets, rivnuts or the like. Chemical attachment features 50 such as adhesives and the like may also be used in some examples. The attachment features 50 connect the attachment portion 48 of the hinge 42 to the lid 36.

In one specific example, the hinge 42 is a gooseneck hinge 42 extending from the pivot pin 46 to the attachment portion 48. However, it should be appreciated that while the hinge 42 has been described and shown in FIGS. 2A-2C as a gooseneck hinge, the hinge 42 may take any of a variety of different forms depending on the packaging, structural, and mechanical requirements of a given motor vehicle 10 in which the center console 16 is disposed. In other aspects, the lid 36 is slidably connected to the center console 16 along a racetrack (not specifically shown). In still further examples, the lid 36 be both slidably and rotatably connected to the center console 16. Additionally, the lid 36 may be monolithic or, as shown in FIGS. 2A-2C, the lid 36 may have a plurality of movable components. That is, in some examples, the lid 36 operates as a single rotatable or slidable piece in relation to the center console 16 itself, while in other examples, the lid 36 may have multiple selectively independently movable sections such as a driver lid portion 52 disposed towards the driver's side of the motor vehicle 10 and a passenger lid portion 54 disposed towards the passenger side of the motor vehicle 10. Each of the driver and passenger lid portions 52, 54 is independently movable relative to the center console 16 and/or to each other. In another example, the driver and passenger lid portions 52, 54 are selectively coupled to one another by a latch mechanism (not specifically shown). The latch mechanism allows a user of the center console 16 to articulate the driver and passenger lid portions 52, 54 separately from one another, and/or together as a single overall lid 36. In the examples of FIGS. 2A-2C, the driver and passenger lid portions 52, 54 are rotatably connected to the center console 16 by the hinge 42 disposed at or proximate a rear end 56 of the center console 16. The hinge 42 of some examples may also be located at other locations around the center console 16 without departing from the scope or intent of the present disclosure. In one example, the hinge 42 is located along the front side 26 of the console compartment providing a front-hinged console lid 36. In another example, the hinge 42 is located along the passenger or driver side 28, 32 of the center console 16 thereby providing a side-hinged lid 36.

The hinge 42 of some examples is selectively engageable. That is, in some examples, a center console 16 of the present disclosure includes a plurality of hinges 42 disposed at various locations around the center console 16 and connecting the lid 36 to the center console 16. The hinges 42 may each be actuated separately when used with a monolithic lid 36. When one of the plurality of hinges 42 is actuated, the others of the plurality of hinges 42 are de-coupled from either the lid 36 or the center console 16, thereby allowing free movement of the lid 36 relative to the console compartment 24 about the axis of rotation for the actuated hinge. Once the lid 36 is closed, the others of the plurality of hinges 42 are re-coupled with either the lid 36 or the center console 16.

While in the foregoing description, the console compartment 24 has been described as having four (front, passenger, rear, driver 26, 28, 30, 32) sides, a bottom 34, and a lid 36, it should be appreciated that the console compartment 24 is defined by the vehicle platform. Accordingly, the console compartment 24 may have more or fewer than four sides, and the bottom 34 may have a substantially non-planar surface. Additionally, while the lid 36 has been described as having either a monolithic or a two-part structure, it should be appreciated that the lid 36 may take other forms including having a structure with more than two selectively independently movable component parts.

Physical dimensions of the console compartment 24 vary in accordance with space constraints within the passenger compartment 12 of the motor vehicle 10. Thus, in a relatively large motor vehicle 10 such as a full-sized pickup truck the center console 16, and therefore, the console compartment 24 each have dimension substantially larger than an equivalent center console 16 and console compartment 24 in a relatively small vehicle such as a sub-compact motor vehicle 10.

Turning now to FIGS. 2A-2C, and with continuing reference to FIG. 1, the console compartment 24 is equipped with a plurality of console dividers 58. The console dividers 58 sub-divide a first volume “V1” defined by the front, passenger, rear, driver 26, 28, 30, 32 sides, bottom 34, and lid 36. In one example, a first console divider 60 extends substantially parallel a longitudinal axis of the motor vehicle 10 from the front side 26 to the rear side 30 of the console compartment 24 and defines a first partial volume “V2”. A second console divider 62 extends substantially perpendicularly to the longitudinal axis of the motor vehicle 10 from the passenger side 28 of the console compartment 24 to the first console divider 60 and defines a second partial volume “V3” and a third partial volume “V4”.

The console compartment 24 is also equipped with a plurality of storage compartments 64. Each of the storage compartments 64 is optimally shaped and sized to fit within the console compartment 24 of the motor vehicle 10, and more specifically within the third partial volume “V4” of the console compartment 24. The storage compartments 64 can be constructed in any of a variety of different manners and from a variety of different materials in accordance with the production specifications and production volume requirements of the application. That is, in some aspects, the storage compartments 64 are constructed of a plastic material, a vinyl material, a metal material, or any other such material that meets predetermined structural characteristics and/or production specification and/or production volume requirements inherent to the application. The storage compartments 64 are formed by rapid prototyping processes such as 3-D printing, directed light fabrication, direct-shell production casting, ballistic particle manufacturing, selected laser sintering, or the like. In other aspects, the storage compartments 64 are formed by injection molding, rotational (roto) molding, extrusion blow molding, injection blow molding, vacuum casting, thermoforming, compression molding, or the like.

The storage compartments 64 each have a plurality of sidewalls including at least a front wall 66 substantially parallel to the front side 26 of the console compartment 24. The front wall 66 extends towards and is connected at an angle to a passenger wall 68. The passenger wall 68 runs substantially parallel to the passenger side 28 of the storage compartment. The passenger wall 68 extends from the front wall 66 to a rear wall 70 to which the passenger wall 68 is connected at an angle. The rear wall 70 runs substantially parallel to the rear side 30 of the console compartment 24. The rear wall 70 extends from the passenger wall 68 to a driver wall 72. The driver wall 72 runs substantially parallel to the driver side 32 of the console compartment 24. The driver wall 72 extends from the rear wall 70 to the front wall 66. The front wall 66 is connected at an angle to the driver wall 72. Each of the front, passenger, rear, and driver walls 66, 68, 70, 72 are connected at an angle to a base portion 74. In several aspects, the base portion 74 forms a substantially planar bottom portion of each of the storage compartments 64. The base portion 74 and the front, passenger, rear, and driver walls 66, 68, 70, 72 are sized and shaped to fit concentrically within the console compartment 24. More specifically, the base portion 74 is shaped and contoured to fit within the architecture of the console compartment 24 of a given motor vehicle 10 application. Moreover, each of the storage compartments 64 is shaped and sized to maximize utility, including maximizing storage capacity of the console compartment 24 and of each of the storage compartments 64. In several aspects, as a means of maximizing storage capacity, each of the front, passenger, rear, and driver walls 66, 68, 70, 72 is angled slightly so that a top portion 56 of each is outside the footprint of the base portion 74. That is, at the top portion 56 each of the storage compartments 64 is wider than at locations proximate the base portion 74. Put another way, the front, passenger, rear, and driver walls 66, 68, 70, 72 flare outwardly from the footprint of the base portion 74 as they extend upward from the base portion 74. Each of the front, passenger, rear, and driver walls 66, 68, 70, 72 and the base portion 74 have a thickness “T” and each of the front, passenger, rear, and driver walls 66, 68, 70, 72 have a wall height (not specifically shown). In several aspects, depending on the method of production, the thickness “T” may vary between the front, passenger, rear, and driver walls 66, 68, 70, 72 and the base portion 74. In other aspects, some manufacturing methods produce front, passenger, rear, and driver walls 66, 68, 70, 72 and base portion 74 having substantially identical thicknesses “T”. In some examples, depending on the architecture of the console compartment 24, at least one of the front, passenger, rear, and driver walls 66, 68, 70, 72 has a wall height lower than at least one of the other walls. By providing at least one of the front, passenger, rear, and driver walls 66, 68, 70, 72 with a lower height than the walls around it, a user of the console compartment 24 may effectively route electrical devices such as cellphone power cables, auxiliary input/output cables, USB cables or the like from a given storage compartment 64 to a power source such as a 12V lighter socket or the like. In some examples, rather than, or in addition to providing at least one of the front, passenger, rear, and driver walls 66, 68, 70, 72 with a decreased height relative to the other walls, at least one of the front, passenger, rear, and driver walls 66, 68, 70, 72 is formed with a passageway (not specifically shown). The passageway is sized and shaped to allow a cellphone charging cable, auxiliary input/output cables, USB cables, or the like, to pass from within the confines of a given storage compartment 64 into the first volume “V1”, the second volume “V2” or to extend entirely outside the confines of the console compartment 24 and into the passenger compartment 12.

In several aspects, each of the storage compartments 64 has a contact portion 76. The contact portions 76 may be located at intersections of each of the front, passenger, rear, and front, passenger, rear, and driver walls 66, 68, 70, 72, along the base portion 74 substantially parallel to front, passenger, rear, and driver walls 66, 68, 70, 72, at other regions on the storage compartments 64 where the storage compartments 64 may contact other components or portions of the console compartment 24. In some examples, the contact portion 76 is formed integrally as a part of the base portion 74 as well as with the front, passenger, rear, and driver walls 66, 68, 70, 72 of the storage compartments 64. The contact portions 76 may be substantially circular protrusions 58 extending from the base portion 74, while in other examples the contact portions 76 are substantially rectilinear protrusions extending from the base portion 74. In some aspects, each of the contact portions 76 is formed of a pliable or resilient material that extends downward from the base portion 74. In some examples, the pliable or resilient material is affixed to the contact portions 76 by an adhesive. The pliable or resilient material is a foam material, a rubberized plastic material, a silicone material, a rubber material, or other such cushioning and noise isolating materials. In some examples, the pliable or resilient material is disposed along at least a portion of the base portion 74 along at least one of the front, passenger, rear, and driver walls 66, 68, 70, 72. By placing the pliable or resilient material on either the contact portions 76, or along the base portion 74 along at least one of the front, passenger, rear, and driver walls 66, 68, 70, 72, the pliable or resilient material is optimally placed to support a first storage compartment 78 of the storage compartments 64 on a second storage compartment 80 of the storage compartments 64. Moreover, a third storage compartment 82 supports the second storage compartment 80 in much the same way as the first storage compartment 78 is supported by the second storage compartment 80.

Each of the first, second, and third storage compartments 78, 80, 82 is provided with a plurality of dividers 84. The plurality of dividers 84 can vary in accordance with packaging constraints, likely occupant use modes, and the like. In some examples, the dividers 84 are formed integrally with each of the first, second, and third storage compartments 78, 80, 82. However, the dividers 84 of each of the first, second, and third storage compartments 78, 80, 82 may be arranged in any of a variety of different orientations. In the example of the first storage compartment 78 in FIGS. 2A-2C, the first storage compartment 78 is substantially devoid of dividers 84, while in the second storage compartment 80, the dividers 84 are arranged so as to divide the second storage compartment 80 into three separate substantially longitudinal sub-compartments 86. Likewise, in the third storage compartment 82, a single divider 84 is provided that sub-divides the third storage compartment 82 into two separate substantially longitudinal sub-compartments 88. While the dividers 84 have been described as dividing the storage compartments 64 into one, two, or three sub-compartments, it should be appreciated that any number of dividers 84 may be provided to divide the storage compartments 64 into any number of sub-compartments depending on the design parameters of a particular motor vehicle 10. Moreover, while the dividers 84 have been shown as dividing the storage compartments 64 substantially longitudinally, it should be appreciated that the dividers 84 may be arranged in any of a wide variety of different arrangements may be used with any of the first, second, or third storage compartments 78, 80, 82 without departing from the scope or intent of the present disclosure. In some aspects, the plurality of dividers 84 are reconfigurable. That is, the dividers 84 of some examples are formed as separate components from the first, second, and third storage compartments 78, 80, 82 themselves. A plurality of guides (not specifically shown) may be formed in the front, passenger, rear, and driver walls 66, 68, 70, 72 of each of the storage compartments 64. The guides are shaped and sized to accept dividers 84 at various locations, thereby allowing an owner/operator of the motor vehicle 10 the ability to reconfigure storage space within each of the storage compartments 64. The dividers 84 are formed of substantially the same material as the storage compartments 64, and by substantially the same processes as the storage compartments 64. The dividers 84 also have a divider height (not specifically shown). The divider height is equal to or less than the wall height. If the divider height is greater than the wall height of a given storage compartment 64, storage compartments 64 stacked vertically above the given storage compartment 64 might not be properly supported on the storage compartment 64 below. Accordingly, the divider height is, in most examples, lower than the wall height of any of the front, passenger, rear, or driver walls 66, 68, 70, 72. In some examples, the divider height “H1” is consistent between the first, second, and third storage compartments 78, 80, 82. When the divider height “H1” is consistent between the first, second, and third storage compartments 78, 80, 82 and the dividers 84 are separate reconfigurable components, each of the dividers 84 may be used in any of the first, second, and third storage compartments 78, 80, 82. In other examples, the dividers 84 have divider heights “H2” that are specific to whichever of the first, second, and third storage compartments 78, 80, 82 the dividers 84 reside within. Accordingly, when the divider heights “H2” are specific to the individual storage compartments 64, the dividers 84 may not efficiently be used in the other storage compartments 64 without impeding the stackability of the storage compartments 64. Additionally, in some examples, the dividers 84 may form a part of the contact portion 76 of a storage compartment 64. In such examples, the divider height is no greater than the largest wall height of the storage compartment 64 in which the divider 74 resides.

The wall height of each of the first, second, and third storage compartments 78, 80, 82 varies from storage compartment 64 to storage compartment 64. That is, the first storage compartment 78 has a first wall height “A”. The second storage compartment 80 has a second wall height “B”. The third storage compartment 82 has a third wall height “C”. In several aspects, the first wall height “A” is different from the second wall height “B”, and the third wall height “C” is different than either the first or the second wall heights “A”, “B”. However, it should be appreciated that according to the application for which the storage compartments 64 are intended, the wall heights “H1” of the storage compartments 64 may vary from each other, or the wall heights “H1” may be the same between the various storage compartments 64.

The storage compartments 64 are in movable connection with the console compartment 24. In some aspects, the movable connection is a hinged and/or sliding connection with the console compartment 24 and the lid 36. More specifically, a first hinge link 90 and a second hinge link 92 are disposed on the first storage compartment 78. The first and second hinge links 90, 92 may be formed integrally with the first storage compartment 78, or the first and second hinge links 90, 92 may be separate components assembled with the first storage compartment 78. The first and second hinge links 90, 92 are substantially flat, planar bracket-like components extending from a first hinge portion 94 to a second hinge portion 96.

The first hinge portion 94 includes a first hinge pin 98 and a first hinge pin receiver 100. The second hinge portion 96 includes a second hinge pin 102 and a second hinge pin receiver 104. In several aspects, the first hinge pin 98 and the second hinge pin 102 may be formed as a portion of the first storage compartment 78, or as separate components assembled with the first storage compartment 78 and the first and second hinge links 90, 92. In another example, the first hinge pin 98 and the second hinge pin 102 may be integrally formed as portions of the first and second hinge links 90, 92 and assembled with the first storage compartment 78. In another example, the first hinge pin 98 and the second hinge pin 102 may be separate components assembled with both the first storage compartment 78 and the first and second hinge links 90, 92.

In one example, the first hinge pins 98 extend into at least one of the front, passenger, rear, driver 26, 28, 30, 32 sides of the console compartment 24 as well as at least one of the console dividers 58. However, the first hinge pins 98 may instead extend from the first hinge pins 98 extend into at least one of the front, passenger, rear, driver 26, 28, 30, 32 sides of the console compartment 24 as well as at least one of the console dividers 58 without departing from the scope or intent of the present disclosure. In the examples of FIGS. 2A and 2C in particular, the first hinge pins 98 extend into first hinge pin receivers 100 formed in the passenger side 28 as well as the first console divider 60. The first hinge pin receivers 100 are formed as substantially linear slots. Thus, the first hinge pin receivers 100 provide a track in which the first hinge pins 98 are allowed to travel. The first hinge pin receivers 100 improve stability and provide limited directional mobility to the first storage compartment 78 relative to the center console 16.

The second hinge pin receivers 104 are formed as orifices in at least one of the front, passenger, rear, and driver walls 66, 68, 70, 72 of the first storage compartment 78, or the first and second hinge links 90, 92 or both. The second hinge pin receivers 104 allows a press-fit engagement, or other such rotatable attachment of the first and second hinge links 90, 92 to the first storage compartment 78 and to the console compartment 24.

In addition, the first storage compartment 78 is formed with first hinge link receiver 105. The first hinge link receiver 105 is shaped to accept, enclose, and substantially immobilize at least the first hinge links 90 with respect to the first storage compartment 78. In some aspects, the first hinge link receiver 105 is substantially shaped as an elongate horseshoe. The first hinge link receiver 105, like the first hinge pin 96 and the first hinge pin receivers 98, improves stability and provides limited directional mobility to the first storage compartment 78. Additional hinge link receivers (not shown) may be formed on the first storage compartment 78, to further directionally stabilize and limit movement of the first storage compartment 78 with respect to the console compartment 24.

The second storage compartment 80 is in hinged communication with the first storage compartment 78. More specifically, a third hinge link 106 extends from a third hinge portion 108 at the second hinge pin 102 to a fourth hinge portion 110. A fourth hinge link 112 extends from a fifth hinge portion 114 rotatably connected to the first storage compartment 78 to a sixth hinge portion 116 rotatably connected to the second storage compartment 80. The fourth hinge link 112 further extends towards and is rotatably connected to the third storage compartment 82 at a seventh hinge portion 118. A fifth hinge link 120 extends from an eighth hinge portion 122 rotatably connected to the second storage compartment 80, to a ninth hinge portion 124 rotatably connected to the third storage compartment 82.

Each of the third, fourth, and fifth hinge links 106, 112, 120 are formed in substantially the same manner and shaped substantially similarly to the first and second hinge links 90, 92 with the exception of the fourth hinge link 112. The fourth hinge link 112 is substantially longer than the third and fifth hinge links 106, 120, and provides a rotatable connection to an additional storage compartment 64 by comparison with the third and fifth hinge links 106, 120. Likewise, the third, fourth, fifth, sixth, seventh, eighth and ninth hinge portions 108, 110, 114, 116, 118, 122, 124 are each formed in substantially the same manner and from substantially similar componentry as the first and second hinge portions 94, 96. That is, each of the third, fourth, fifth, sixth, seventh, eighth, and ninth hinge portions 108, 110, 114, 116, 118, 122, 124 utilize a hinge pin and a hinge pin receiver to provide rotational movement between the first, second, and third storage compartments 78, 80, 82, the center console 16, and the lid 36. Furthermore, each of the hinge pins described above includes a bushing material that provides for smooth operation of the third, fourth, fifth, sixth, seventh, eighth, and ninth hinge portions 108, 110, 114, 116, 118, 122, 124 and reduces the potential for fatigue and/or failure of the third, fourth, fifth, sixth, seventh, eighth, and ninth hinge portions 108, 110, 114, 116, 118, 122, 124 with long-term use.

The third storage compartment 82 is also in sliding engagement with the lid 36 via a slider 126 within a racetrack 128. In several aspects, the slider 126 is a pin having any of a variety of different shapes. In one example, the slider 126 has a shape approximating the head of a screw, a brad, a bolt, or the like. In another example, the slider 126 is a spring-loaded apparatus having a post portion (not specifically shown) extending from the third storage compartment 82 and a collapsible arm or arms (not shown). The collapsible arm or arms are inserted into the racetrack 128 in a collapsed position. In the collapsed position, the collapsible arm or arms are disposed parallel to and in direct contact with the post portion. Once the collapsible arm or arms are inserted into the racetrack 128, the collapsible arm or arms move from the collapsed position to an expanded position. In the expanded position, the collapsible arm or arms approximates a “t-shape” and engages with the racetrack 128 in a manner that retains the collapsible arm or arms within the racetrack 128. Furthermore, once the collapsible arm or arms of the slider 126 are inserted into the racetrack 128, the slider 126 engages with the racetrack 128 and moves along the racetrack in a second range of motion “R2”. The second range of motion “R2” is limited by a stop 130. In several aspects, the stop 130 is an end or ends of the orifice forming the racetrack 128. In another aspect, the stop 130 is a separate component inserted into the racetrack 128 and defining one or more limits of the racetrack 128. The racetrack 128 may take any of a variety of different constructions depending on the design parameters of a given application. In one example, the racetrack 128 is a substantially linear slot-shaped orifice in the substantially planar underside 38 of the lid 36. In another example, the racetrack 128 further includes a ball bearing track allowing smooth and low resistance movement of the slider 126 within the racetrack 128. In a further example, the racetrack 128 includes a gasket material allowing the post of the slider 126 to extend from the racetrack 128 to the third storage compartment 82, while preventing unwanted materials such as crumbs, dust, dirt, or the like, from entering the racetrack 128 and decreasing the smoothness of the operation of the racetrack.

In combination, the slider 126 within the racetrack 128 and the first, second, third, fourth, and fifth hinge links 90, 92, 106, 112, 120 translate articulation of the lid 36 into articulation of each of the first, second, and third storage compartments 78, 80, 82. That is, as the lid 36 of the center console 16 is opened, the slider 126 engages within the racetrack 128 to cause the third storage compartment 82 to rise up and out of the console compartment 24. Movement of the third storage compartment 82 is coupled to movement of the second storage compartment 80 via the third, fourth, and fifth hinge links 106, 112, 120. Thus, as the third storage compartment 82 rises up and out of the console compartment 24, the third fourth, and fifth hinge links 106, 112, 120 cause the second storage compartment 80 to rise up and out of the console compartment 24 as well. However, because of the placement of the third, fifth, sixth, seventh, and eighth hinge portions 108, 114, 116, 118, 122, the movement of the second storage compartment 80 is slightly decreased by comparison with the third storage compartment 82. That is, the second storage compartment 80 articulates through a third range of motion “R3” that is both vertically and horizontally smaller than a fourth range of motion “R4” through which the third storage compartment 82 moves. Movement of the second storage compartment 80 is coupled to movement of the first storage compartment 78 via the third and fourth hinge links 106, 112 and the second, third, fourth, and fifth hinge portions 96, 108, 110, 114. The first storage compartment 78 has a fifth range of motion “R5” that includes only vertical movement, however, as movement of the first storage compartment 78 is limited by the first hinge link receiver 105 in combination with the first hinge pins 98 within the first hinge pin receiver 100 slots. Accordingly, as the lid 36 is articulated from the closed position “P1” to the open position “P2”, the motion of the lid 36 is tied to vertical and horizontal movement of the third storage compartment 82 which movement is further coupled to vertical and horizontal movement of the second storage compartment 80, which movement is further coupled to vertical movement of the first storage compartment 78. When the lid 36 is in the closed position “P1”, the first storage compartment 78 rests proximate the bottom 34 of the console compartment 24 and fully within the third partial volume “V4”. Likewise, the second storage compartment 80 rests overtop the first storage compartment 78 and fully within the third partial volume “V4”, and the third storage compartment 82 rests overtop the second storage compartment 80 and fully within the third partial volume “V4”. Thus, in some aspects, the first, second, and third storage compartments 78, 80, 82 interact with the lid 36 and the console compartment 24 somewhat like a fishing tackle box. While in the foregoing description, the center console 16 has been described as having first, second, and third storage compartments 78, 80, 82, linked together by a plurality of hinge portions 94, 96, 108, 110, 114, 116, 118, 122, 124 and hinge links 90, 92, 106, 112, 120, in sliding connection with the lid 36 via a slider 126 within a racetrack 128, it should be appreciated that any number of storage compartments 64 in hinged connection with one another and with the console compartment 24 and the lid 36 are contemplated herein.

A console compartment 24 having hinged storage compartments 64 of the present disclosure offers several advantages. These include the ability to be retrofitted to current and future motor vehicles 10 at low cost, while offering a user of the motor vehicle 10 the ability to neatly and efficiently organize belongings within the console compartment 24. Additionally, the hinged storage compartments 64 allow a user to easily organize and access items stored in the various storage compartments 64 without needing to manually separate the storage compartments 64 from the console compartment 24. Additionally, the decreased height of at least one of the front, passenger, rear, or driver walls 66, 68, 70, 72 allow a user the ability to conveniently use a power source, USB port, or other such auxiliary input/output while still taking advantage of the hinged multi-tiered storage compartments 64 for storage.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A console for a motor vehicle comprising:
a console compartment formed in the console and comprising:
a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable compartment lid disposed overtop the console compartment and articulating through a first range of motion;
a plurality of storage compartments in movable connection with each of the others of the plurality of storage compartments and in movable connection with the console compartment and the movable compartment lid, wherein when the lid articulates through the first range of motion, the plurality of storage compartments move vertically and horizontally with respect to the console compartment and the movable compartment lid.

2. The console of claim 1 wherein the console compartment further comprises a plurality of console dividers dividing the first volume into a plurality of partial volumes.

3. The console of claim 2 wherein the plurality of storage compartments are disposed within a first partial volume of the plurality of partial volumes when the movable compartment lid is in a closed position, and wherein the plurality of storage compartments are disposed outside of the first partial volume when the movable compartment lid is in an open position.

4. The console of claim 3 wherein the plurality of storage compartments further comprises:
a first storage compartment movably connected to the console compartment by a first hinge link and a second hinge link, and by a first hinge pin and a second hinge pin;
a second storage compartment movably connected to the first compartment by a third hinge link, and a fourth hinge link, and by a third hinge pin, a fourth hinge pin, a fifth hinge pin, and a sixth hinge pin;
a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid.

5. The console of claim 4 wherein each of the first, second, and third storage compartments comprises:
a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion.

6. The console of claim 4 wherein the first hinge link is disposed in a hinge link receiver formed with the first storage compartment, and wherein the first hinge link in the hinge link receiver is immobilized relative to the first storage compartment.

7. The console of claim 4 wherein the movable connection between the third storage compartment and the movable compartment lid further comprises a sliding connection, wherein the sliding connection comprises a slider extending from the third storage compartment into a racetrack, wherein movement of the slider within the racetrack is limited by a stop disposed in the racetrack.

8. The console of claim 7 wherein the racetrack further comprises a slot formed in an underside of the movable compartment lid.

9. The console of claim 7 wherein the racetrack further comprises a ball bearing track.

10. The console of claim 7 wherein the racetrack further comprises a gasket.

11. The console of claim 4 wherein when the movable compartment lid articulates through the first range of motion from the closed position to the open position, the third storage compartment articulates vertically and horizontally through a second range of motion out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment.

12. A console having hinged storage compartments for a motor vehicle comprising:
a console compartment formed in the console and comprising:
a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable compartment lid disposed overtop the console compartment and articulating through a first range of motion;
a plurality of storage compartments in movable connection with each of the others of the plurality of storage compartments and in movable connection with the console compartment and the movable compartment lid, the plurality of storage compartments including:
a first storage compartment movably connected to the console compartment by a first hinge link and a second hinge link, and by a first hinge pin and a second hinge pin;
a second storage compartment movably connected to the first compartment by a third hinge link, and a fourth hinge link, and by a third hinge pin, a fourth hinge pin, a fifth hinge pin, and a sixth hinge pin; and
a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid,
wherein when the lid articulates through the first range of motion, the plurality of storage compartments move vertically and horizontally with respect to the console compartment and the movable compartment lid.

13. The console of claim 12 wherein the console compartment further comprises a plurality of console dividers dividing the first volume into a plurality of partial volumes, and wherein the plurality of storage compartments are disposed within a first partial volume of the plurality of partial volumes when the movable compartment lid is in a closed position, and wherein the plurality of storage compartments are disposed outside of the first partial volume when the movable compartment lid is in an open position.

14. The console of claim 13 wherein when the movable compartment lid articulates through the first range of motion from the closed position to the open position, the third storage compartment articulates through a second range of motion vertically and horizontally out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment.

15. The console of claim 12 wherein each of the first, second, and third storage compartments comprises:
a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion.

16. The console of claim 12 wherein the first hinge link is disposed in a hinge link receiver formed with the first storage compartment, and wherein the first hinge link in the hinge link receiver is immobilized relative to the first storage compartment.

17. The console of claim 12 wherein the movable connection between the third storage compartment and the movable compartment lid further comprises a sliding connection, wherein the sliding connection comprises a slider extending from the third storage compartment into a racetrack formed in the underside of the movable compartment lid, wherein the racetrack is a substantially linear slot, wherein the slider moves through a fifth range of motion, and the fifth range of motion is limited by a stop disposed in the racetrack.

18. The console of claim 17 wherein the racetrack further comprises a ball bearing track, and wherein a gasket is disposed in the racetrack.

19. The console of claim 17 wherein the slider further comprises a pin extending from the third storage compartment and into the racetrack, the pin has a substantially T-shaped cross section, and the pin is retained within the racetrack.

20. A center console for a motor vehicle having hinged storage compartments comprising:
a console compartment formed in the console and defining a first volume, and a movable compartment lid disposed overtop the console compartment and articulating through a first range of motion;
a plurality of storage compartments in movable connection with each of the others of the plurality of storage compartments and in movable connection with the console compartment and the movable compartment lid, the plurality of storage compartments including:
a first storage compartment movably connected to the console compartment by a first hinge link and a second hinge link, and by a first hinge pin and a second hinge pin; wherein the first hinge link is disposed in a hinge link receiver formed with the first storage compartment, the first hinge link in the hinge link receiver is immobilized relative to the first storage compartment, and the first hinge pin travels in a substantially linear slot-shaped hinge pin receiver formed in the console compartment;
a second storage compartment movably connected to the first compartment by a third hinge link, and a fourth hinge link, and by a third hinge pin, a fourth hinge pin, a fifth hinge pin, and a sixth hinge pin;
a third storage compartment movably connected to the first storage compartment and the second storage compartment by the fourth hinge link and a fifth hinge link, and by a seventh hinge pin, an eighth hinge pin, and a ninth hinge pin, the third storage compartment also movably connected to the movable compartment lid through a sliding connection, wherein the sliding connection comprises a slider having a substantially T-shaped cross section and extending from the third storage compartment into a racetrack formed in the underside of the movable compartment lid, wherein the racetrack is a substantially linear slot; and
a plurality of console dividers dividing the first volume into a plurality of partial volumes, and wherein the plurality of storage compartments are disposed within a first partial volume of the plurality of partial volumes when the movable compartment lid is in a closed position, and wherein the plurality of storage compartments are disposed outside of the first partial volume when the movable compartment lid is in an open position,
wherein when the movable compartment lid articulates through the first range of motion from the closed position to the open position, the third storage compartment articulates through a second range of motion vertically and horizontally out of the first partial volume, the second compartment articulates through a third range of motion vertically and horizontally out of the first partial volume and remains below and horizontally offset from the third storage compartment, and the first storage compartment articulates through a fourth range of motion vertically out of the first partial volume and remains below and horizontally offset from the second storage compartment, and wherein the slider moves through a fifth range of motion within the racetrack, and the fifth range of motion is limited by a stop within the racetrack.
